(19) United States
(12) Patent Application Publication
(10) Pub. No.: US 2012/0215892 A1
(43) Pub. Date: Aug. 23, 2012

(54) SYSTEM AND METHOD TO CUSTOMIZE DNS REPLIES BASED ON CONNECTION IDENTITY

(76) Inventors: Kelly Wanser, Thornton, CO (US); Hilda Fontana, Pasadena, CA (US); Bryan Costales, San Francisco, CA (US); Ajay Gopal Royan, San Francisco, CA (US)

(21) Appl. No.: 13/094,790

(22) Filed: Apr. 26, 2011

Related U.S. Application Data
(60) Provisional application No. 61/445,159, filed on Feb. 22, 2011.

(51) Int. Cl. G06F 15/177

(52) U.S. Cl. 709/222

(57) ABSTRACT

A highly advantageous domain name system and method are disclosed for receiving and replying to queries for information associated with at least one Internet connected domain in which replies to queries are based at least in part on the identity of the querying entity.

### RELATED APPLICATIONS

The present application claims priority from U.S. Provisional Application Ser. No. 61/445,159, filed on Feb. 22, 2011, which is incorporated herein by reference.

### BACKGROUND

In the Internet, domain names allow users to navigate by remembering words rather than numbers to get to specific web sites or other Internet resources. Each Internet connected domain has at least one domain name and/or corresponding Internet Protocol (IP) address. The Domain Name System (DNS) keeps track of the domain names and each of the associated IP addresses along with other information associated with the Internet domains. The DNS is configured to receive requests or queries for information about the domains and to respond to the queries with replies that contain the requested information. The DNS includes a number of Internet connected domain name servers with memory for storing the domain information. The DNS can store and supply several types of records for each domain, such as: A (Address record) queries, NS (Name Server) queries, MX (Mail eXchange) queries TXT (Text record), and others. These records can be used for various purposes including email and determining the IP address for the associated domain.

The DNS operates to reply to queries from querying entities with a reply that contains the requested information about a specific domain. Querying entities can be, for example, a host, client, domain, or other entity that is connected to the Internet and which can query for information from the DNS. The DNS can be used when sending emails by providing MX and/or TXT records information related to the receiving domain of the email. During an exemplary conventional operation of the DNS, a query is made to the DNS from a querying entity for the TXT record associated with the domain “example.com. ” The DNS finds the TXT record for the domain in the DNS memory and returns the requested TXT record to the querying entity. The DNS replies to queries for the TXT record of the domain with the same information regardless of the identity of the querying entity. While in certain infrequent instances, the DNS may reply to the query for the TXT record of the domain with incorrect information that is different from other replies that contain the correct information, this reply of incorrect information is not based on any meaningful information or parameter.

Email is an asynchronous expedient to communicate over the Internet. Email remains popular despite the rise in instant digital-communication standards such as cell-phone texting. Businesses like to send email because complex information may be digested by the reader at the reader's leisure. Two risks common to all email are spam (unsolicited email) and phishing (fraudulently masquerading email). Several standards have been adopted in attempting to reduce these risks and will continue to be adopted. Among the currently used standards are DKIM (a method to digitally sign email so that the identity of the sender may be found and so that the email message cannot be transformed during transit without detection) and sender policy framework or SPF (Sender Policy Framework, a method to state the IP addresses of the email sender's email sending machines to prevent fraudulent emails).

In order to implement reduction of email associated risks, email sending policy can be encapsulated in the DKIM, SPF and other standards. The standards are based on DNS, and each policy can be a text record (type TXT) looked up using DNS. For instance, DKIM is looked up based on concatenating a special prefix to the sender's domain. For DKIM that prefix is formed by a selector followed by a dot and then the string constant “_domainkey.” As another example, in SPF the text record is looked up by querying the domain name. A new standard recommends that SPF data be looked up using a DNS SPF type of record. The common aspect to all these and at least some future standards is that they are based on DNS.

The appeal and usefulness of email is diminished if the email recipient cannot trust that a message is from the person or business that it purports to be from. Typically, the source address of an email is displayed on the recipient's email program to allow the user to see whom the email is supposed to be from. This display allows the recipient to decide whether to open the email if it is from a trusted source or to delete the email if it is from an unknown or untrustworthy source. However, like other computerized systems, email has been subjected to disruption and attack by computer hackers. Hackers are able to replace the source address of emails, thereby making an illegitimate email appear to be from a trusted source. This practice is referred to as email spoofing. The illegitimate emails are frequently fraudulent, which refers to unsolicited commercial advertisements (spoofed or not), often sent in mass mailings. The hackers replace the source address so the unsuspecting recipient believes that the email is from a known or trusted source and opens the email.

In the early days of email, there existed no compelling reason for email to all be sent from a central email server. Many businesses routinely sent email directly from regional centers to customers. With the rise of spam and phishing, however, a need has developed for a business to create a single central email sending identity. Part of that change requires the business to undergo an email audit (to insure no unforeseen email is sent from outside the email center) and to install software to force all email be sent through the email center. As part of centralization, the business can adopt or later adopt one or more of the existing or proposed email authentication standards.

Applicants recognize that even with the introduction of the single email sending identity and the adoption of email authentication standards, risk continues to exist because of the different ways email receiving sites handle bad email. Some email receiving sites will reject or discard bad email. Other sites will merely move bad email into a “spam” folder. If a sending business is just beginning to sign all out-bound email, that business may not want failed signatures to be discarded because some of the emails with failed signatures may still be legitimate in this transitional stage. Part of the standards is a preference for how the sender wants failed email to be handled. This information can be obtained through a query to the DNS about the sender. However, these conventional standards are believed by Applicants to be unable to address the situation where some legitimate emails from a sender are discarded because of failed signatures while other legitimate emails with valid signatures from the sender are not discarded.

The present invention provides a highly advantageous apparatus and method that are submitted to resolve the foregoing problems and concerns while providing still further advantages, as described hereinafter.

### SUMMARY OF THE INVENTION

The present invention overcomes the limitations of a conventional domain name system. In one embodiment, according to the present disclosure, a method is disclosed in an Internet connected Domain Name System (DNS) that is configured for receiving and replying to queries for information associated with at least one Internet connected domain from a plurality of querying entities each having an entity indicator that uniquely identifies the entity. In the method, information associated with the domain is defined to have at least two different subsets of the information associated with the domain. One of the subsets of information is selected for use in replying to a query based at least in part on the entity indicator of the querying entity.

In another embodiment, a method is disclosed which involves an Internet connected Domain Name System (DNS) that is configured to receive and reply to information queries about at least one Internet connected domain from a plurality of querying entities each having an entity indicator that is usable to determine an identity of the querying entity. Information associated with the domain to be used for replying to the information queries about the domain is configured into subsets of information. At least one subset is configured with special response information for replying to at least one querying entity that is predetermined to receive the special response information based on the entity indicator of the querying entity. At least one other subset is configured with general response information for replying to at least one querying entity that is not predetermined to receive the special response information based on the entity indicator of the querying entity. The configured information is stored in a memory device.

Yet another embodiment involves an Internet connected Domain Name System (DNS) that is configured to receive and reply to information queries about at least one Internet connected domain from a plurality of querying entities each having an entity indicator that is usable to determine an identity of the querying entity. This embodiment includes a memory device for storing domain information associated with the domain to be used for replying to the information queries about the domain. A computer is included that is communicatively connected to the memory device and arranged to allow for configuration of the domain information in the memory device into at least two different subsets. At least one of the subsets is configured for replying to a query for information about the domain based at least in part on the identity of the querying entity.

Other objects, features and advantages of the present invention will be apparent from the accompanying drawings and from the detailed description that follows.

### BRIEF DESCRIPTION OF THE DRAWINGS

FIG. 1 is a block diagram which illustrates a system arranged according to an embodiment of the present disclosure.

FIG. 2 is a flow diagram illustrating an embodiment of a method for the operation of a customized DNS.

FIG. 3 is a flow diagram illustrating an embodiment of a method involving identification of a querying entity.

FIG. 4 is a flow diagram illustrating an embodiment of a method for determining a reply in an emailing.

FIG. 5 is a flow diagram illustrating an embodiment of a method for determining a reply to a query based on an identification of the querying entity.

FIG. 6 is a block diagram which illustrates an embodiment of a customized DNS server.

FIG. 7 is a flow diagram illustrating an embodiment of a method for modification of a conventional DNS server.

FIG. 8 is a block diagram which illustrates another embodiment of a customized DNS server.

FIG. 9 is a flow diagram illustrating an embodiment for retrieving information from a delegated DNS server.

FIG. 10 is a flow diagram illustrating an embodiment for delegating information to a new server from a conventional DNS server.

### DETAILED DESCRIPTION OF THE INVENTION

While this invention is susceptible to embodiment in many different forms, there are shown in the drawings, and will be described herein in detail, specific embodiments thereof with the understanding that the present disclosure is to be considered as an exemplification of the principles of the invention and is not to be limited to the specific embodiments described. Descriptive terminology may be adopted for purposes of enhancing the reader's understanding, with respect to the various views provided in the figures, and is in no way intended to be limiting.

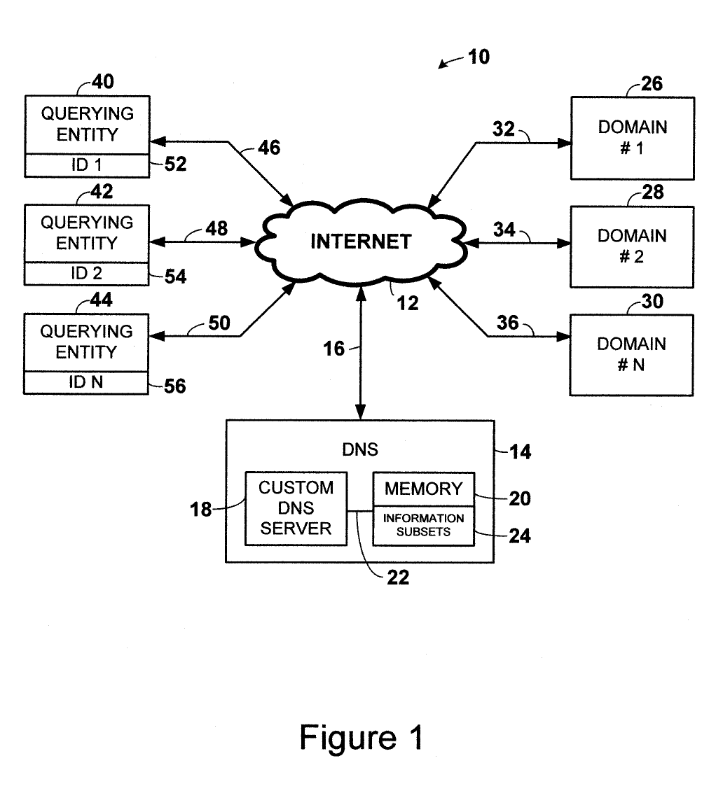

Referring to the drawings, wherein like components may be indicated by like reference numbers throughout the various figures, FIG. 1 illustrates a block diagram of an Internet environment generally referred to by the reference numeral 10. Internet 12 represents the numerous interconnected servers and other hardware that makes up the Internet. Connected to or integral with Internet 12 is Domain Naming System (DNS) 14. DNS 14 is communicatively connected to the Internet by a communication line 16 which carries communication data to and from the Internet. DNS 14 includes a customized DNS server 18 and a DNS memory 20 that is communicatively coupled to server 18 through communication line 22 for storing subsets of information 24. DNS memory 20 can be part of DNS server 18 or separate from DNS server 18 Other DNS servers can be connected to or included in Internet 12 and can be considered to be part of the overall DNS. These servers can include one or more DNS servers such as those described herein and can include a number of conventional Internet connected domain name servers. These conventional domain name servers operate to reply to queries with domain information that is not dependent on the identity of the querying entity. Customized DNS server 18 operates to provide replies to queries to the DNS based on the identity of the querying entity, as will be discussed in greater detail below.

Domains 26, 28 and 30 are communicatively connected to Internet 12 by communication lines 32, 34 and 36, respectively. Domains 26, 28 and 30 are representative of one or more Internet connected domains. Information related to domains 26, 28 and 30 is stored in memory 20 of the DNS. Memory 20 can store and supply several types of records for each domain, such as: A (Address record) queries, NS (Name Server) queries, MX (Mail eXchange) queries TXT (Text record), and others. These records can be used for various purposes including email policy and determining the IP address for an associated domain. This information can include the domain name, the IP address of the domain, email information, and other information.

Querying entities 40, 42 and 44 are communicatively connected to Internet 12 by communication lines 46, 48 and 50, respectively, and each have a unique entity indicator 52, 54 and 56, respectively. The querying entities can be domains and/or hosts or other Internet entities that access the Internet and which query DNS 14 for information about domains 26, 28 and 30. The querying entities can query the DNS for information used for navigating to the domain through a web browser, for email delivery instructions for emails from the domain and other information available in the records stored in the DNS. The entity indicator can be a host name, host IP address, domain name, domain IP address or other information that uniquely identifies the querying entity with which the entity indicator is associated. While domains 26, 28 and 30; querying entities 40, 42 and 44; and DNS 14 are shown separate from Internet 12, these can also be considered to be part of the Internet. When a query is made to the DNS from a querying entity about one of the domains, the DNS can determine the identity of the querying entity.

As can be understood in view of the embodiments brought to light herein, stored information concerning the various domains can be customized or configured based on the identity of the querying entity. This customized information can then be used to reply to queries for information about the domains based at least in part on the identity of the querying entity. Replying to queries based on the identity of the querying entity allows the DNS to provide different customized domain information to different entities. A domain administrator, or other person having authority in this regard, can define customized information that will be used for replies to queries for the domain or domains under their administration based on the identity of the querying entity. In some instances the customized information can relate to the delivery of emails from a domain or email sender for which the administrator sets email delivery policy. For example, a special response subset of the information can be designated to be sent in the case of a query by selected entities, whereas a general response subset of the information can be designated to be sent in the case of a query from unknown or non-selected entities. Different special response subsets of the information can be designated to be sent to different querying entities.

As an example, in a situation in which an email sender is the domain with special response subsets of information stored in the DNS, if the email sender knows that some email will be badly signed, that email sender might want to have one preference stated to the email receiving site that discards bad messages, and to have a different preference stated to the email receiving site that moves bad messages into a “spam” folder. Such an arrangement is currently not available. None of the existing standards of which Applicants are aware allow such DNS queries to be answered one way for some receiving sites and in other ways for other receiving sites.

As another example, where a bank has a domain email sender and might wish to DKIM sign its email with a weak 512 bit signing key when sending emails bank-to-bank over a TLS (Transport Layer Security) connection. This would be an example of a first type of special response subset of information. That same bank might wish to DKIM sign using a stronger 1024 bit signing key when sending email to customers. This would be an example of a second type of special response subset of information. The bank then may have a general response subset of information that is used when sending emails that are not bank-to-bank emails or customer emails. Because there are different receiving sites of emails that the bank sender wishes to handle differently, the DNS information can have different subsets of information that are supplied depending on the different receiving site.

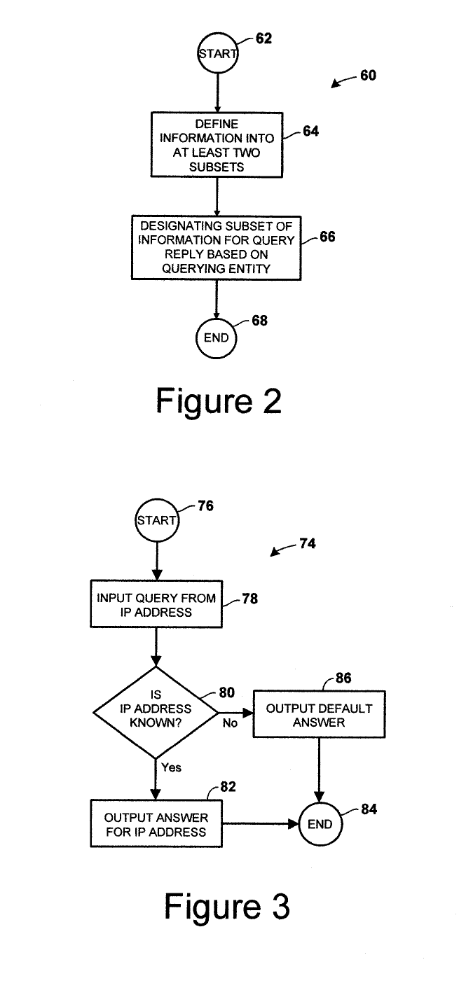

FIG. 2 illustrates an embodiment of a method that is generally referred to by reference number 60, which can be used for setting up DNS server 18 in FIG. 1 for replying to queries for information based on the identity of the querying entity. Method 60 begins at 62 and proceeds to a step 64 where the information associated with at least one of domains 26, 28 and 30 is defined to have at least two different subsets. The subsets of information associated with the domain can be stored in DNS memory 20 for later access by DNS 18 in response to a query from one or more of the querying entities 40, 42 or 44. Method 60 then proceeds to step 66 where one of the subsets of information is designated for use in replying to a query based at least partially on the entity indicator of the querying entity. The selected subset can be a subset of the information that is customized specifically for a particular one of the querying entities, or can be a subset of the information customized for particular groups of querying entities. Method 60 ends at step 68. By defining at least two different subsets of information for at least one of the domains, the DNS can reply to queries about the domain with a selected one of the subsets based on the identity of the querying entity.

FIG. 3 illustrates a method that is generally referred to by reference number 74, which can operate in the DNS server 18 in FIG. 1. Method 74 begins at 76 and proceeds to step 78 where a query for information is received from a querying entity having an IP address for information regarding a domain. Method 74 then proceeds to step 80 where a decision is made as to whether the IP address of the querying entity is a known IP address or an unknown IP address. If the IP address is known, then method 74 proceeds to step 82 where a reply is sent that contains the special response subset of information about the domain and which is intended for the known IP address. Method 74 then proceeds to 84 where the method ends. On the other hand, if at step 80 the IP address is not a known IP address, method 74 proceeds to step 86 where a reply is sent to the querying entity that contains general response subset of information that is intended for unknown IP addresses. Method 74 then proceeds to step 84 where the method ends. In this embodiment, by determining if the IP address of the querying entity is known or unknown, method 74 can reply to the query with a special response subset of the information or with a general response subset of the information. Of course, the DNS can reply to at least some known IP addresses with the general response subset of the information when those IP addresses have been designated to receive the general response subset of information. Also, different querying entities with known IP addresses can receive different or the same subsets of information.

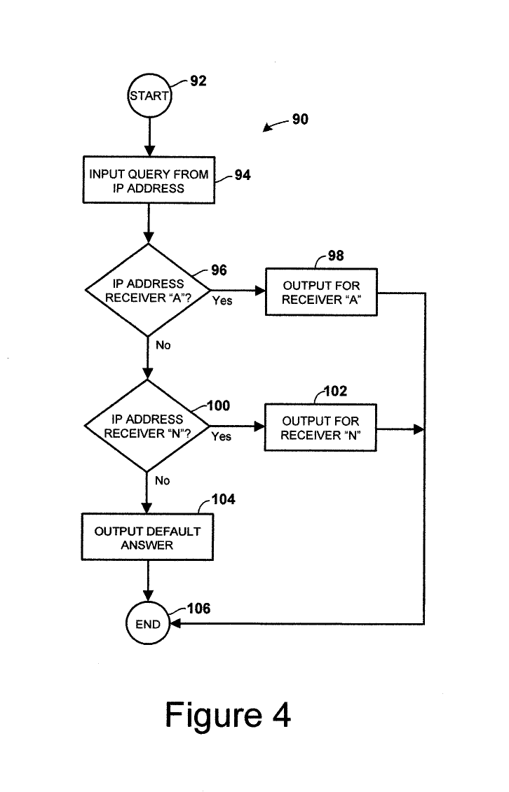

A receiving network or receiver in an email application is an example of a querying entity. In the transfer of an email from a sender to a receiver, the appropriate receiver can be determined by the sender from a plurality of different receivers using the DNS and the recipient's email address, obtained from the header of the message. Once the appropriate receiver receives the email, the receiver looks up information in the DNS on how the email should be handled. In this situation the receiver is the querying entity and queries the DNS by looking up the information in the DNS on how the email from the sender, should be handled. Different information for the handling of the email can be supplied by the DNS depending on the identity of the receiver. In one embodiment, the email sender can define the information in the DNS so that different receivers get different subsets of information in replies from the DNS. For example, different special response subsets of information can be associated with different receivers. FIG. 4 illustrates a method involving emailing that is generally referred to by the reference number 90, which can operate in DNS 18 shown in FIG. 1. Method 90 begins at 92 and proceeds to step 94 where a query is received for information from a querying entity that is identifiable by a specific IP address that can be obtained by the query. Method 90 then proceeds to step 96 where a determination is made as to whether the IP address of the querying entity is an IP address that belongs to a specific receiver “A”. If the determination is that the IP address is for receiver “A”, then method 90 proceeds to step 98 where a reply is sent to the querying entity that contains a special response subset of information specific to receiver “A”. Method 90 then proceeds to 106 where the method ends.

If the determination at step 96 is that the IP address is not receiver “A” then method 90 proceeds to step 100 where a determination is made as to whether the IP address of the querying entity is an IP address that belongs to a specific receiver “N”. There can be numerous different receivers in method 90 and these are represented by “A” to “N”. The “A” receiver represents a first receiver and “N” represents the last receiver, any number of IP addresses can be determined for receivers in between receiver “A” and receiver “N”. If the determination is that the IP address is for receiver “N”, then method 90 proceeds to step 102 where a reply is sent to the querying entity that contains a different special response subset of information specific to receiver “N”. Method 90 then proceeds to 106 where the method ends. If the determination at step 100 is that the IP address is not receiver “N” then method 90 proceeds to step 104 where a reply is sent to the querying entity that contains a general response subset of the information. Method 90 then proceeds to 106 where the method ends. Receivers “A” and “N” are exemplary of specific email receivers.

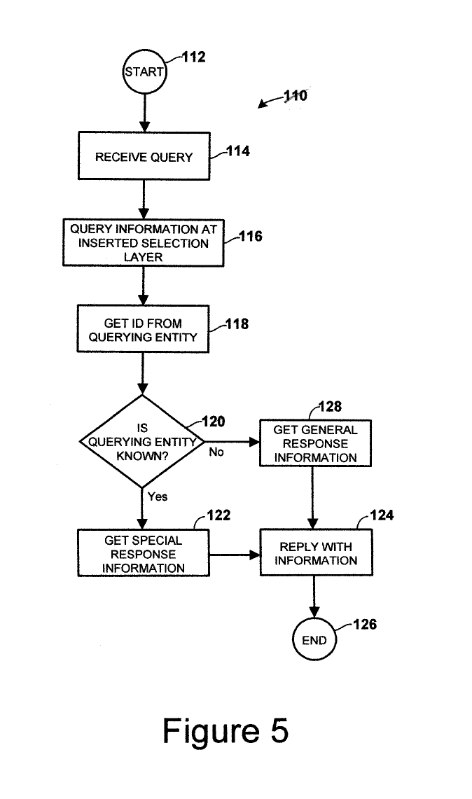

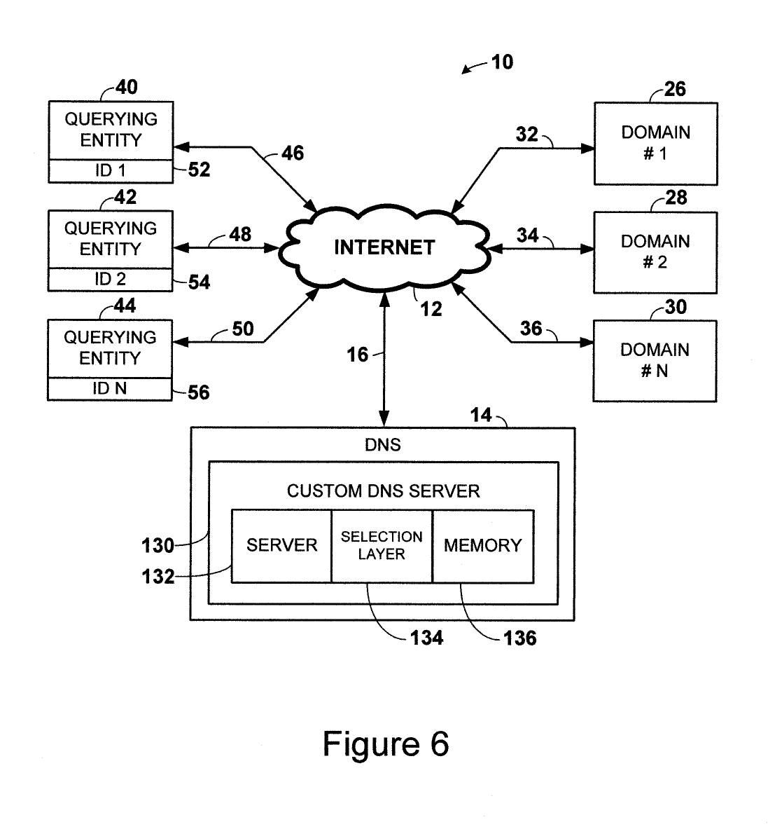

An embodiment of a method for replying to queries based on the querying entity's identification is shown in FIG. 5 and is generally indicated by the reference number 110. Method 110 is illustrative of the operation of a customized DNS server 130 in FIG. 6. DNS server 130 can be a part of DNS system 14 shown in FIG. 1 which is communicatively connected to the Internet 12 through communication line 16. The customized DNS in this embodiment includes a selection layer 134 that is inserted between a server 132 and a memory 136. Memory 136 can be a memory cache and can be read/write or read-only memory media such as a disk or other type of memory. In this instance, cache memory 136 is shown as integral to customized DNS server 130 however the memory can be separate from customized DNS server 130.

Method 110 begins at 112 and proceeds to a step 114 where DNS server 132 receives a query through DNS 14 and communication line 16 from querying entity 40, 42 or 44 over Internet 12 for information regarding one of Internet connected domain 26, 28, or 30. The query includes the identity indicator 52, 54 or 56 respectively depending on which querying entity 40, 42 or 44 is making the query. Method 110 then proceeds to step 116 where DNS server 132 refers to inserted selection layer 134 for the queried information. Method 110 then proceeds to step 118 where inserted selection layer 134 receives the identity indicator of the querying entity, such as the host IP address or host name, from the server 132.

Method 110 then proceeds to step 120 where a decision is made as to whether the querying entity is a known entity or an unknown entity. A known entity can be an entity that is designated to receive a special information subset in response to queries. An unknown entity can be an entity that is not recognized by the DNS server and is therefore not designated to receive a special information subset in response to queries. If it is determined that the querying entity is known, then method 110 proceeds to step 122 where the memory is accessed for the subset of information that is designated for that particular querying entity. Method 110 then proceeds to step 124 where a reply is sent to the querying entity with the appropriate information, in this instance, the special response subset of information. Method 110 then proceeds to step 126 where method 110 ends.

If it is determined that the querying entity is unknown at step 120, then method 110 proceeds to step 128 where the memory is accessed for the general response subset of information. Method 110 then proceeds to step 124 where a reply is sent to the querying entity with the appropriate information, in this instance, the general response subset of information. Method 110 then proceeds to step 126 where method 110 ends. A conventional, un-modified DNS server, would look up the queried information directly from the memory cache instead of accessing or referring to the inserted selection layer, and would return the same reply regardless of the identity of the querying entity.

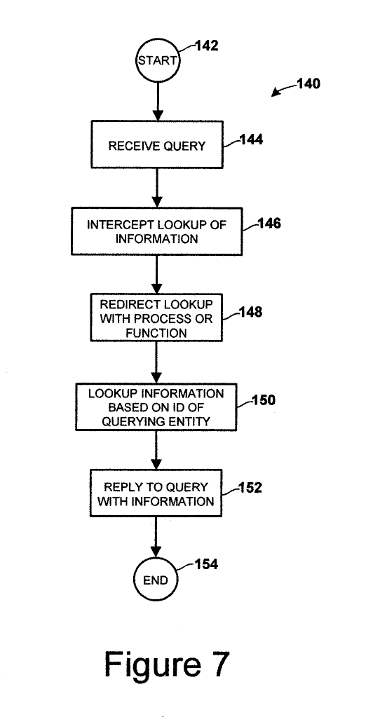

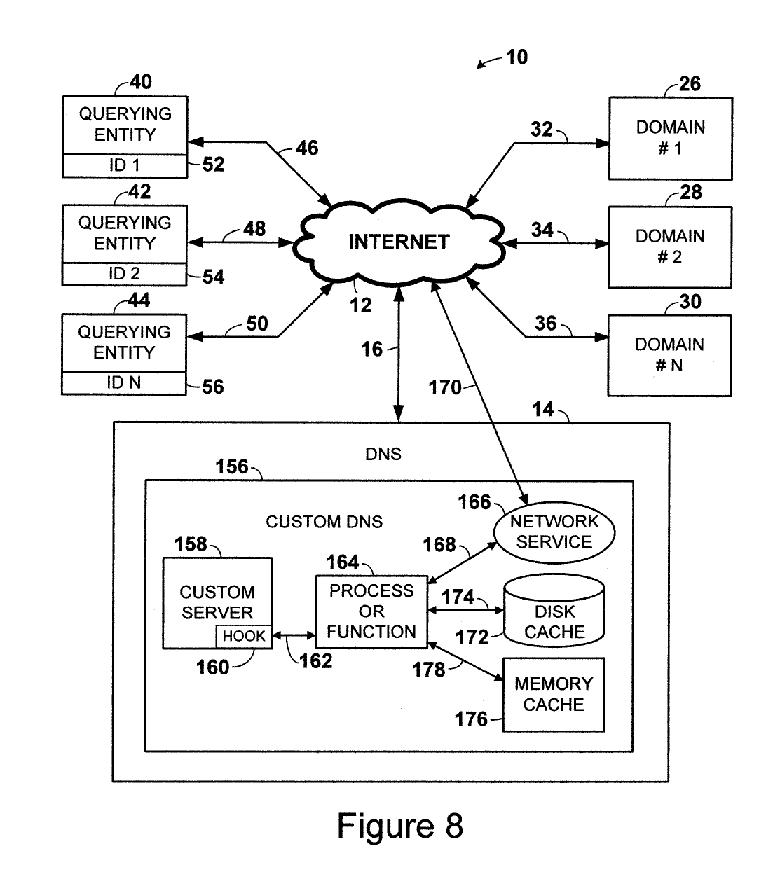

Another embodiment of a method for replying to queries based on the querying entities identification is shown in FIG. 7 and is generally indicated by reference number 140. Method 140 is illustrative of the operation of a customized DNS 156 in FIG. 8. DNS 156 can be a portion of the overall DNS system 14 serving the Internet which is illustrated as communicatively connected to the Internet by communication line 16. The customized DNS in this embodiment includes a customized server 158 that has a software hook 160. As will be seen, the hook can be arranged to intercept and redirect the lookup of information in response to a query in the customized DNS.

Method 140 begins at 142 and proceeds to step 144 where a query for information relating to a domain is received. Method 140 then proceeds to step 146 where the software hook intercepts or hooks the lookup of information that a conventional DNS would otherwise perform in response to the received query. Method 140 then proceeds to step 148 where the query is redirected from the hook to a process and/or function 164 over a link 162. In one embodiment where the intercepted query is redirected to a function, the function can be a function call. In another embodiment, the query is redirected to a process, the process can be one or more of a command-line argument, inter-process communication, semaphore and/or token exchange as will be recognized by one of ordinary skill in the art having this overall disclosure in hand. Method 140 then proceeds to step 150 where the process or function looks up the information from memory for the received query based on the identity of the querying entity. The information has a subset of special response information for at least one known querying entity and a subset of general response information for at least one unknown querying entity. Step 150 can involve one or more of the following embodiments for looking up the queried information.

In one embodiment, the information can be looked up at step 150 from a network service 166 over a network link such as a socket connection 168. In another embodiment, the information can be looked up from a disk cache 172 over a disk link 174. The disk cache can include a database or one or more files on one or more disk based storage devices. In another embodiment, the information can be looked up from a memory cache 176 over a memory link 178. The memory cache can comprise non-volatile memory or some other type of memory having a memory based database. The memory can be a shared memory. Once the appropriate information is obtained from memory based on the identity of the querying entity, method 140 proceeds to step 152 where the information is supplied to the querying entity in a reply. In one embodiment, the information can be passed back to hook 160 from process or function 164 over link 162 and then the DNS server 158 can use the information to reply to the query. Method 140 then proceeds to step 154 where method 140 ends.

The customized DNS server, just as is the case with the customized DNS servers described above, can be configured to reply to the full range of possible DNS queries from known and unknown querying entities; or can be configured to reply to queries for select information, such as by way of example, TXT or other types of records.

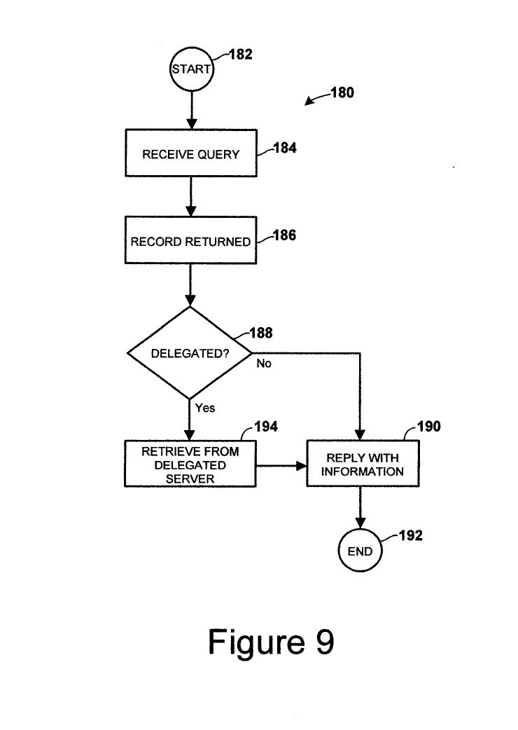

In an embodiment illustrated by FIG. 9, a method in which the DNS is able to reply to a query for information that has been delegated by an administrator to a different server is generally indicated by the reference number 180. In some instances, certain portions of DNS records or information related to a domain may be delegated to a different DNS server than other portions of the information. One or more subsets of the information can be configured to include one or more preferences that are selectable by a domain administrator. For example, a domain administrator may want to have TXT, or other records delegated to a different server so that special response subsets of the TXT information can be provided to certain querying entities while a general response subset of the TXT information can be provided to other querying entities. In this situation, a querying entity may not know where the information sought or queried information can be found, i.e. whether the queried information has been delegated or not.

Method 180 begins at 182 and proceeds to step 184 where a query for TXT information, by way of example, is received by the DNS regarding a domain. Method 180 then proceeds to step 186 where information regarding the queried domain is returned within the DNS in response to looking up the TXT record for the domain name. Method 180 then proceeds to step 188 where a decision is made as to whether the returned information indicates that the TXT record for the domain has been delegated to another server or if the TXT record is in the current server. In this instance, if the returned information indicates that the TXT record is in the current server, then the decision at 188 is negative and the returned information includes the queried information. Method 180 then proceeds to step 190 where the information is sent to the querying entity in a reply. Method 180 then proceeds to step 192 where the method ends.

If the decision at step 188 is that the TXT record has been delegated to another DNS server based on the information retrieved by step 186, then method 180 proceeds to step 194 where the information is retrieved from the delegated server. By delegating a portion of the DNS information to a different server, the delegated portion of information, in this instance the TXT record, can be defined as subsets of information in the server to which the portion of information is delegated without affecting the remainder of the information which was retrieved by step 186 and includes, for example, the location of the delegated portion of information, as will be further described below. From step 194, method 180 then proceeds to step 190 where the subset of TXT information appropriate to the querying entity is sent to the querying entity in a reply. Method 180 then proceeds to step 192 where the method ends.

An Internet domain is a name assigned to an entity, where that entity may or may not physically exist. Two or more fields of a domain name are separated from each other by a single period character between each field. The fields are read left to right, becoming less specific toward the right. Top level (most general) domains are at the right, such as “.com” and “.gov”. An Internet domain name is composed of at least two fields: a local identifier; and a top level domain. For example, the Internet domain name “example.com” has two fields, each separated from the other by a single period character. The local part (field) is “example”; the top level part (field) is “com”.

Delegation of a portion of the information can in some instances be accomplished using existing DNS software. In the example illustrated by FIG. 9, a TXT or other type of information record can be delegated to a different name server using Unix BIND software. While the present examples can use the framework of Unix Bind software, it should be appreciated that other suitable software of this kind, either currently available or yet to be developed can be used by one of ordinary skill in the art having this overall disclosure in hand. An SPF record can form part of the TXT record returned by the DNS server to the querying entity when looking up a TXT record for the domain name. In this instance, a first line returned in response to a query to an initial (e.g., current) DNS server using BIND can be:

@IN TXT v=spf1 include:_spf1

In this example, the “@” symbol represents the current DNS server domain name specified by the query. If the current DNS server domain is “example.com”, the “@” represents “example.com”. The SPF TXT record returned is: “v=spf1 include:_spf” which means that additional SPF information can be found at the host “_spf”. Because the “_spf” lacks a dot, the statement indicates that the SPF information in the current DNS server domain, the “@” domain, and therefore the SPF information has not been delegated to another domain or server. It should be appreciated by those having ordinary skill in the art that other records such as spf2 and others can replace spf1 in this example. A second line returned in response to a query to a DNS server using BIND can be:

_spf IN NS ns.example.com.

In this instance, the second line is the record for the “_spf' name. Its value is a NS (name server) record which states that the name server is “example.com”. If the current domain, the “@”, is xxx.yyy, the query will be made for a TXT record for the host “_spf.xxx.yyy” which will be looked up at the name server “ns.example.com.” A third line can be:

sel._domainkey IN NS ns.example.com.

The third line illustrates a DKIM record. DKIM records are usually TXT records, but here the DKIM record for “sel._domainkey” is an NS record. The result of the third line is that a lookup of the TXT record for “sel._domainkey.xxx.yyy” will be made at the name server “ns.example.com”. In this instance in FIG. 9, at step 188 the decision would be that the record has been delegated to “example.com”. By delegating TXT or other records to another name server, those records can be custom returned based on the entity indicator of the querying entity, such as the IP address.

A sub-domain is a naming convention whereby a more local field is added to the left of the local part. For example, “morelocal.example.com” has three fields: “morelocal”, “example”, and “com”. The “morelocal” field is the most local field (the leftmost field) and so is considered to be under “sub” the higher domain “example.com”. Thus, as a naming convention, “morelocal.example.com” is a sub-domain of “example.com”.

The term “sub-domain” is called a naming convention because there is no way to determine, merely by its name, if a multi-part domain name is the name of a host or the name of a domain containing one or more hosts. Using the Domain Naming System (DNS), one may differentiate between a host and a domain by querying for NS (Name Server) records. A host will lack such records, but a domain will contain such records. If the information associated with the name “morelocal.example.com”, includes a NS record when the DNS is queried, then it is a sub-domain of “example.com”. If the information associated with the name “morelocal.example.com”, does not include NS records when the DNS is queried then it is the name of a host inside the “example.com” domain. In no way should the use of specific standards in the examples herein be construed as limiting the scope of this application to the specific standard. Other standards including other email authentication and/or authorization standards and those standards yet to be developed or adopted may be used as can be appreciated by those of ordinary skill in the art.

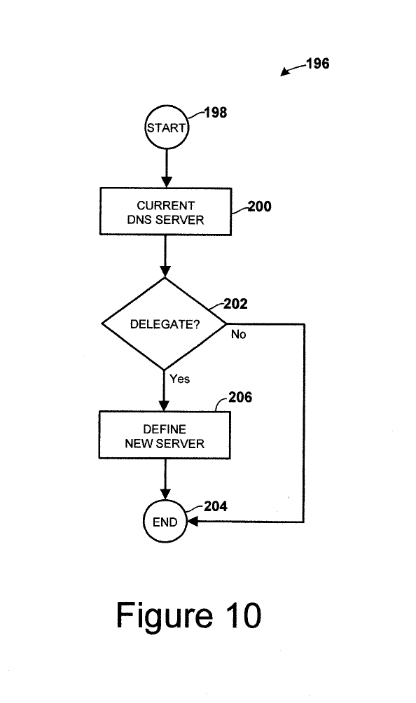

In an embodiment illustrated by FIG. 10, one embodiment of a method by which a sub-domain can be delegated to a new server is generally indicated by the reference number 196. Method 196 begins at 198 and proceeds to step 200 where the current DNS server for a sub-domain named “subdomain” is determined. Method 196 then proceeds to step 202 where a determination is made as to whether the sub-domain is to be delegated to a new or different server. If the determination at step 202 is that it is not to be delegated then method 196 proceeds to step 204 where the method ends. If the determination at step 202 is that the sub-domain is to be delegated to a new or different server then method 196 proceeds to step 206 where the new or different server is defined. Method 196 then proceeds to step 204 where the method ends. By way of example, when using Unix BIND software, the subdomain can be changed by using the following line 4:

subdomain IN NS ns.example.com.

In this instance, the name of the sub-domain is “subdomain” and line 4 causes the DNS records to be looked up at the name server “ns.example.com”. By delegating the sub-domain, all records of that sub-domain will be found at another, different server “ns.example.com”. By delegating records to another name server, TXT records, among other types of records, can be custom returned based on later querying IP addresses or other querying entity identities.

The advanced DNS server of the present disclosure can be communicatively connected to the memory device and arranged to allow for configuration of the domain information in the memory device through the DNS server or through another computer. The domain information can be configured into subsets of information where different subsets can be used for replying to queries from different querying entities. A domain administrator, DNS administrator or other person having authority can access the information and define the information into the subsets for various querying entities. Access to the information can be controlled so that only authorized persons can configure the information. Access to the information for configuration purposes can also be provided without going through the DNS server. That is, for example, other computers may be connected to the memory device storing the information and can be used for accessing and configuring the information. Various types of access can be provided, including through a keyboard, mouse or other interface and configuration software can be used to manipulate and define the information to be used for various replies to various queries from various querying entities.

The special response information can be configured specifically for one or more selected querying entities while unknown querying entities can receive general response information that can be configured specifically for unknown querying entities or the general response information can be information that would otherwise be used for replies from a conventional DNS server for the queried domain. The special response information can be stored in one location and the general response information can be stored in another, different location. For instance, the general response information can be stored in the DNS cache while the special response information can be stored in a network accessed database that is at a separate site from the DNS cache. In these instances, the domain administrator may have access to the special response information through an interface that is connected directly to the database. In this situation, the domain administrator may have physical access to the network database.

The ability to provide special response information to select querying entities can be provided on a payment basis. In this embodiment, domains can subscribe to a service which allows different responses to queries about the domain to different querying entities. Separate customized DNS servers can be used to provide the special response information to queries from known entities.

In one or more embodiments disclosed, modifying the cache used by DNS servers so that replies can be custom constructed based on the querying IP address or its corresponding domain name has been discussed. Although it may be impractical to modify all DNS servers worldwide, if an email sender or other administrator wants to have its DNS thusly handled, that administrator may delegate DNS services for that record to a business that performs this customized DNS reply. Delegation can be performed on a record by record basis, or the administrator may prefer to delegate an entire sub-domain. By arranging for all DNS queries to be delegated to a single DNS server, the administrator can thereafter offer one DNS reply having a subset of information to one or more receiving sites, and another DNS reply having at least another subset of information to one or more other receiving sites.

Other embodiments also disclose replying to DNS queries one way for some querying IP addresses or their corresponding domain names, and replying differently for other querying IP addresses. This system can be further defined by subscriber customer preferences, where those preferences determine the nature of each DNS reply. The administrators of the domains where queries are replied based on the querying entity can be customers of a provider of this service. These customers may be paying or non-paying.

Another embodiment involves modifying the way a DNS server looks up its replies. Normally the DNS server finds reply data or information in its cache. Another method for finding that data is by making a call to a separate process or function. In this method the cache of the DNS server is unmodified, and instead a software hook is installed so that the DNS server performs its lookup using an external process or a function compiled or linked into the DNS server. Since modification of all DNS servers worldwide may be difficult, one or more such customized DNS servers can be offered as a service to customers with need for them.

Although IP addresses may have been discussed as separate from a host name, nothing prevents IP address from being hosts and/or host names from being IP addresses. For example, a host name may have more than one IP address associated with it. Also, a given IP address may have more than one physical host associated with it, as represented by different ports.

While a number of exemplary aspects and embodiments have been discussed above, those of skill in the art will recognize certain modifications, permutations, additions and sub-combinations thereof. It is therefore intended that the following appended claims and claims hereafter introduced are interpreted to include all such modifications, permutations, additions and sub-combinations as are within their true spirit and scope.

What is claimed is:

1. In an Internet connected Domain Name System (DNS) configured for receiving and replying to queries for information associated with at least one Internet connected domain from a plurality of querying entities each having an entity indicator, a method comprising:
defining the information associated with the domain to have at least two different subsets of the information associated with the domain; and
designating at least one of the subsets of information for use in replying to a query based at least in part on the entity indicator of the querying entity.

2. The method according to claim 2, wherein the aforementioned designated subset of information is a first subset of information and further comprising:
configuring the first subset of information for use in replying to queries from querying entities that are designated to receive the first subset of information and configuring at least one other subset of the information for use in replying to queries from all other querying entities.

3. The method according to claim 2, wherein the first subset of information is configured to include at least one preference that is selectable by a domain administrator of the domain.

4. The method according to claim 1, wherein the DNS includes a memory cache, said method further comprising:
storing the designated subset of information in the memory cache of the DNS.

5. The method as defined in claim 1, further comprising:
storing the designated subset of information in a memory device that is accessible by the DNS.

6. The method as defined in claim 5, wherein the memory device is accessible by the DNS using a network.

7. The method as defined in claim 5, wherein the memory device is accessible by the DNS using a socket based service.

8. The method as defined in claim 1, further comprising:
storing the designated subset of information in a database.

9. The method as defined in claim 1, further comprising:
storing the designated subset of information in a read/write memory.

10. The method as defined in claim 1, further comprising:
storing the designated subset of information in a read-only memory.

11. The method as defined in claim 1, further comprising:
storing the designated subset of information in a flash-based memory.

12. The method as defined in claim 1, further comprising:
storing the designated subset of information in a disk-based memory.

13. In an Internet connected Domain Name System (DNS) configured to receive and reply to information queries about at least one Internet connected domain from a plurality of querying entities each having an entity indicator that is usable to determine an identity of the querying entity, a method comprising:
configuring information associated with the domain to be used for replying to the information queries about the domain into subsets of information where at least one subset is configured with special response information for replying to at least one querying entity that is predetermined to receive the special response information based on the entity indicator, and at least one other subset is configured with general response information for replying to at least one querying entity that is not predetermined to receive the special response information based on the entity indicator; and
storing the configured information in a memory device.

14. A method as defined in claim 13, said method further comprising:
designating at least one of the plurality of querying entity as predetermined to receive the special response information;
receiving a query for information from the designated querying entity using the DNS, where the received query for information includes the entity indicator of the designated querying entity;
determining that the querying entity is the designated querying entity based on the received entity indicator;
accessing the special response information of the configured information from the memory device; and
replying to the query for information from the designated querying entity including at least the special response information.

15. A method as defined in claim 14, wherein the DNS includes a DNS server and the query for information is received by the DNS server, said method further comprising:
configuring the DNS server to communicate with a different server when determining that the querying entity is the designated querying entity.

16. A method as defined in claim 14, wherein the DNS includes a DNS server and the query for information is received by the DNS server, and wherein storing the configured information includes storing at least the special response information in the memory device in a different server and wherein the DNS server communicates with the different server when accessing the special response information.

17. A method as defined in claim 14, further comprising:
installing a software hook in the DNS to intercept the received query for information and to supply the reply to the query to the DNS.

18. A method as defined in claim 17, wherein the DNS includes a DNS server and the query for information is received by the DNS server and the software hook is installed in the DNS server and wherein at least the special response information is stored in the memory device in a different server and the DNS server communicates with the different server when accessing the special response information.

19. A method as defined in claim 17, wherein the software hook uses a function call to determine that the querying entity is the designated querying entity and to access the special response information.

20. A method as defined in claim 17, wherein the software hook uses a process with at least one command line argument to determine that the querying entity is the designated querying entity and to access the special response information.

21. A method as defined in claim 17, wherein the software hook uses an inter-process communication to determine that the querying entity is the designated querying entity and to access the special response information.

22. A method as defined in claim 17, wherein the software hook uses a semaphore in determining that the querying entity is the designated querying entity and for accessing the special response information.

23. A method as defined in claim 17, wherein the software hook uses a token exchange in determining that the querying entity is the designated querying entity and in accessing the special response information.

24. A method as defined in claim 13, wherein the determination is based on the entity indicator that is an IP address of the designated querying entity.

25. A method as defined in claim 13, wherein the designated querying entity is a domain and the determination is based on the entity indicator that is an IP address of the domain.

26. A method as defined in claim 13, wherein the designated querying entity is a host and the determination is based on the entity indicator that is an IP address of the host.

27. A method as defined in claim 13, wherein the designated querying entity is a host and the determination is based on the entity indicator that is a host name of the host.

28. A method as defined in claim 13, wherein the designated querying entity is a domain and the determination is based on the entity indicator that is a domain name of the domain.

29. A method as defined in claim 13, wherein the special response information is related to email sending policy.

30. A method as defined in claim 29, wherein the email sending policy includes information related to DomainKeys Identified Mail.

31. A method as defined in claim 29, wherein the email sending policy includes information related to Sender Policy Framework.

32. A method as defined in claim 29, wherein the email sending policy includes a text record.

33. A method as defined in claim 29, wherein the email sending policy includes a bit length of an email signing key.

34. A method as defined in claim 13, wherein the memory device is cache of the DNS.

35. A method as defined in claim 34, wherein the DNS cache includes existing information related to the domain, and said method includes modifying the existing information by storing the configured information in the DNS cache.

36. A method as defined in claim 35, wherein existing information included in the DNS cache includes the general response information subset.

37. A method as defined in claim 34, wherein storing the configured information in the memory device includes storing the special purpose information subset in one portion of the DNS cache and storing the general response information subset in a different portion of the DNS cache.

38. A method as defined in claim 13, wherein the configured information is stored remote from the DNS and is accessible by the DNS over a network link.

39. A method as defined in claim 13, wherein the special response subset of information is configured at least partially by an administrator of the domain.

40. In an Internet connected Domain Name System (DNS) configured to receive and reply to information queries about at least one Internet connected domain from a plurality of querying entities each having an entity indicator that is usable to determine an identity of the querying entity, an apparatus comprising:
a memory device storing domain information associated with the domain to be used for replying to the information queries about the domain; and
a computer communicatively connected to the memory device and arranged to allow for configuration of the domain information in the memory device into at least two different subsets, where at least one of the subsets is configured for replying to a query for information about the domain based at least in part on the identity of the querying entity.

41. The apparatus as defined in claim 40 wherein the computer is arranged to be accessible by a domain administrator of the domain to allow the domain administrator to configure the domain information.

42. The apparatus as defined in claim 40 wherein the memory device is a memory cache of the DNS.

43. The apparatus as defined in claim 40 wherein the memory device is a database.

44. The apparatus as defined in claim 40 wherein the memory device is a read/write memory.

45. The apparatus as defined in claim 40 wherein the memory device is a read-only memory.

46. The apparatus as defined in claim 40 wherein the memory device is a flash-based memory.

47. The apparatus as defined in claim 40 wherein the memory device is a disk-based memory.

48. The apparatus as defined in claim 40 wherein the memory device is a network connected memory.

49. The apparatus as defined in claim 40 wherein the memory device includes a socket based service for connection to the computer.

50. The apparatus as defined in claim 40 wherein the computer is a part of the DNS.

51. The apparatus as defined in claim 50 wherein the memory device is a memory cache of the DNS.

52. The apparatus as defined in claim 50, further comprising a network connected between the computer and the DNS for communicating the domain information from the computer to the DNS to allow the DNS to include the domain information in replies to information queries.

53. The apparatus as defined in claim 52, wherein the computer is located remotely from the DNS and the network is the Internet.
